(19) United States
(12) Patent Application Publication
(10) Pub. No.: US 2005/0013772 A1
(43) Pub. Date: Jan. 20, 2005

(54) Non-oxidizing hydrocarbon fuel reformer and a method of performing the same

(76) Inventors: Edward M. Patton, Torrance, CA (US); John P. Dering, Lakewood, CA (US); James Kenneth Thomas, Aliso Viejo, CA (US); Strahinja Zecevic, Tustin, CA (US); Parviz Parhami, Redondo Beach, CA (US)

Correspondence Address: MURPHEY & MURPHEY, A.P.C., 701 PALOMAR AIRPORT ROAD, SUITE 260, CARLSBAD, CA, 92009, US

(21) Appl. No.: 10/894,186

(22) Filed: Jul. 19, 2004

Related U.S. Application Data
(60) Provisional application No. 60/488,515, filed on Jul. 17, 2003.

(51) Int. Cl. C01B 3/06

(52) U.S. Cl. 423/658.2

(57) ABSTRACT

A system and a method is provided for a hydrocarbon fuel reformer. The system and method include a technique for separating hydrocarbon fuels into smaller particles and/or droplets. Separating the hydrocarbon fuels into smaller particles and/or droplets allows for the hydrogen and carbons to be separated. The hydrocarbons are broken down into smaller particles and then dissociated into gaseous hydrogen and particulate carbon. Once dissociated, the mixture can be separated to produce hydrogen and carbon in elemental state for use as fuels.

### FIELD OF THE INVENTION

This invention relates to the field of hydrogen fuel systems. More specifically, this invention relates to a system and a method for breaking down hydrocarbon fuels. Further, the invention relates to a system and a method for breaking down hydrocarbon fuels to produce a hydrogen gas and solid particles without oxidizing the hydrocarbon fuel. Moreover, this invention relates to a system and method for separating the hydrogen gas from the solid particles from a gaseous and non-gaseous fuel source.

### BACKGROUND OF THE INVENTION

Typical hydrocarbon fuel reformers on the market today are used to produce hydrogen for fuel cell applications. An example of hydrocarbon fuel reformers is the use of fuel cells that have a general use in automotive technology. The prior art fuel reformers use a partial oxidation process to produce hydrogen and a mixture of carbon monoxide and carbon dioxide. See for example, United States Patents to: Lomax et al. U.S. Pat. No. 6,623,719; Struthers et al., U.S. Pat. No. 6,620,537; Kiryu et al., U.S. Pat. No. 6,565,817. These prior art fuel reformers produce hydrogen and a mixture of carbon monoxide and carbon dioxide because the production of solid carbon in a reformer usually results in “coking” of the reformer. More specifically, “coking” occurs wherein the gas flow passages become clogged with the solid carbon particulate that has been separated from the hydrocarbon mixture. “Coking” and/or clogging of the gas flow passages greatly diminishes the effectiveness of fuel cell use, because the gas flows are lower and not constant. However, there are situations where a gaseous hydrogen and a particulate byproduct would be advantageous. Such a situation arises when the particulate can be used in a different type of fuel cell application, such as, for example direct carbon-air fuel cells. Therefore if both the hydrogen and the carbon from the hydrocarbons could be used as fuel in a fuel cell application, the overall efficiency of the resulting electrical generator would be greatly increased.

A need therefore exists for a reformer that may provide the ability to separate the fuel into droplets small enough to be reformed. A need also exists for a means of separating the fuel into a gaseous hydrogen and solid particles. Further, a need exists for a means that may remove the solid particles from the flowing stream of hydrogen gas.

### SUMMARY OF THE INVENTION

The present invention provides a system and a method for separating hydrocarbon fuels into smaller droplets such that the hydrogen and the solid particulate may be separated. More specifically, the present invention provides a system and a method for splitting hydrocarbon fuels into hydrogen gas and solid particulate.

To this end, in an embodiment of the present invention, a system for reforming non-gaseous hydrocarbon fuels is provided. The system has a dispensing means for dividing the hydrocarbon fuel into small droplets. Moreover, the system has a dissociating means for dissociating the hydrocarbon fuel into hydrogen gas and solid particles. Further, the system has a separating means for separating said solid particles from said hydrogen gas.

In another embodiment, the system has a dispensing means for separating the hydrocarbon fuel wherein said dispensing means is a nozzle.

In another embodiment, the system has a dispensing means for separating the hydrocarbon fuel wherein said dispensing means is a injector, grinder, atomizer or other means of dividing into very small particles or droplets.

In another embodiment, the system has a dissociating means wherein said dissociating mean converts the hydrocarbon fuel into gaseous hydrogen and solid particles by using a radio frequency discharge plasma that efficiently dissociates the Carbon-Hydrogen bond.

In another embodiment, the system has a dissociating means wherein said dissociating means converts the hydrocarbon fuel into gaseous hydrogen and solid carbon by using radio frequency plasma discharge tuned to a frequency or frequencies that most efficiently dissociates the carbon-hydrogen bond.

In another embodiment, the system has a separating means for separating said solid particles from said hydrogen gas wherein said separating means is acoustic flocculation.

In another embodiment, the system has a separating means for separating said solid particles from said hydrogen gas wherein said separating means is filter membranes, electromagnetic separating techniques, the use of a bias voltage on a substrate in the bottom of the separation means, or use of other small particles separation techniques.

In another embodiment, the system has a separating means for separating said solid particles from said hydrogen gas wherein said separating means is acoustic flocculation further wherein said acoustic flocculation agglomerates the solid carbon particulate to increase the mass of each particle to the point that the force of gravity will separate the agglomerated particles from the flowing hydrogen stream.

In an embodiment of the present invention, a system for reforming gaseous hydrocarbon fuels is provided. The system has a dissociating means for dissociating the hydrocarbon fuel into hydrogen gas and solid particles. Moreover, the system has a separating means for separating said solid particles from said hydrogen gas.

In another embodiment, the system has a dissociating means wherein said dissociating means converts the hydrocarbon fuel into gaseous hydrogen and solid particles by using a radio frequency discharge plasma that efficiently dissociates the carbon-hydrogen bond.

In another embodiment, the system has a dissociating means wherein said dissociating means converts the hydrocarbon fuel into gaseous hydrogen and solid particles by using radio frequency plasma discharge tuned to a frequency or frequencies that most efficiently dissociates the carbon-hydrogen bond or the carbon-carbon bond.

In another embodiment, the system has a separating means for separating the dissociated hydrocarbon into solid particles and gas wherein said separating means is acoustic flocculation and further wherein said acoustic flocculation agglomerates the solid particles to increase the mass of each particles to the point that the force of gravity will separate the agglomerated particles from the flowing hydrogen stream.

In another embodiment, the system has a separating means for separating the dissociated hydrocarbon into solid particles and gas wherein said dispensing means is filter membranes, electromagnetic separating techniques, the use of a bias voltage on a substrate in the bottom of the separating means, or use of other small particles separation techniques.

In an embodiment of the present invention, a method for producing gaseous hydrogen and solid particles from non-gaseous hydrocarbon fuels is provided. The method comprising the steps of: dividing the fuel into very small particles; dissociating the hydrocarbon fuel particles into gaseous hydrogen and solid particles; separating the dissociated solid particles from the gaseous hydrogen.

In another embodiment, the method includes the step of: providing a means of dividing hydrocarbon fuel into particles wherein hydrogen-carbon bonds that exist in the hydrocarbon fuel may be broken wherein said means of dividing hydrocarbon fuel is a nozzle, injector, grinder, atomizer, or other means to divide the hydrocarbon fuels into small particles or droplets.

In another embodiment, the method includes the step of: providing a means of dissociating the solid particles from the hydrogen and producing gaseous hydrogen and solid particulate wherein said dissociating means is a radio frequency plasma discharge.

In another embodiment, the method includes the step of: providing a means of dissociating the solid particles carbon from the hydrogen and producing gaseous hydrogen and solid particulate wherein said dissociating means is plasma discharge created by a capacitive or inductive coil discharge device.

In another embodiment, the method includes the step of: providing a means of separating the gaseous hydrogen from the solid particles such that the gaseous hydrogen and the solid particles can then be used in their natural state wherein said separating means is acoustic flocculation to agglomerate the solid particles to increase the mass of each particle to the point that the force of gravity separates the agglomerated particles from a hydrogen stream.

In another embodiment, the method includes the step of: providing a means of separating the gaseous hydrogen from the solid particles such that the gaseous hydrogen and the solid particles can then be used in their natural state wherein said separating means is electromagnetic separation techniques, bias voltage on a substrate in the bottom of the separation means that will attract the solid particulate and cause the solid particulate to settle and be removed, or any small particle separating technique to remove the solid particle from the divided hydrocarbon fuel.

In another embodiment, the method includes the step of: reforming hydrocarbon fuels for a fuel cell which does not oxidize the hydrocarbon fuel.

In another embodiment, the method includes the step of: producing a solid particle fuel in addition to the gaseous hydrogen.

In another embodiment, the method includes the step of: removing the solid particulate from the gaseous hydrogen.

In another embodiment, the method includes the step of: utilizing the solid particles in a carbon fuel cell and utilizing the gaseous hydrogen in a hydrogen fuel cell.

In an embodiment of the present invention, a method for producing gaseous hydrogen and solid particles from gaseous hydrocarbon fuels is provided. The method comprising the steps of: dissociating the hydrocarbon fuel into gaseous hydrogen and solid particles; separating the dissociated solid particles from the gaseous hydrogen.

In another embodiment, the method includes the step of: providing a means of dissociating the solid particles from the hydrogen and producing gaseous hydrogen and solid particulate wherein said dissociating means is a radio frequency plasma discharge.

In another embodiment, the method includes the step of: providing a means of dissociating the solid particles carbon from the hydrogen and producing gaseous hydrogen and solid particulate wherein said dissociating means is plasma discharge created by a capacitive or inductive coil discharge device.

In another embodiment, the method includes the step of: providing a means of separating the gaseous hydrogen from the solid particles such that the gaseous hydrogen and the solid particles can then be used in their natural state wherein said separating means is acoustic flocculation to agglomerate the solid particles to increase the mass of each particle to the point that the force of gravity separates the agglomerated particles from a hydrogen stream.

In another embodiment, the method includes the step of: providing a means of separating the gaseous hydrogen from the solid particles such that the gaseous hydrogen and the solid particles can then be used in their natural state wherein said separating means is electromagnetic separation techniques, bias voltage on a substrate in the bottom of the separation means that will attract the solid particulate and cause the solid particulate to settle and be removed, or any small particle separating technique to remove the solid particle from the divided hydrocarbon fuel.

In another embodiment, the method includes the step of: reforming hydrocarbon fuels for a fuel cell which does not oxidize the hydrocarbon fuel.

In another embodiment, the method includes the step of: producing a solid particle fuel in addition to the gaseous hydrogen.

In another embodiment, the method includes the step of: removing the solid particulate from the gaseous hydrogen.

In another embodiment, the method includes the step of: utilizing the solid particles in a carbon fuel cell and utilizing the gaseous hydrogen in a hydrogen fuel cell.

It is, therefore, an advantage of the present invention to provide a system and a method for producing gaseous hydrogen from hydrocarbon fuels.

Another advantage of the present invention is to provide a system and a method for producing solid particulate directly from hydrocarbon fuels.

Still another advantage of the present invention is to provide a system and a method for producing gaseous hydrogen and solid particles at high efficiency.

Another advantage of the present invention is to provide a system and a method for atomizing the fuel through a nozzle.

Yet another advantage of the present invention is to provide a system and a method for dividing the fuel into very small droplets.

An advantage of the present invention is to provide a system and a method for producing gaseous hydrogen and solid particulate by dividing the fuel into droplets small enough to be reformed.

Still another advantage of the present invention is to provide a system and a method for producing gaseous hydrogen and solid particulate that may be highly compact.

Yet another advantage of the present invention is to provide a system and a method for producing gaseous hydrogen and solid particulate that may be a robust fuel reformer.

Another advantage of the present invention is to provide a system and a method for dissociating hydrocarbon fuels wherein the hydrocarbon fuel may be solid.

An advantage of the present invention is to provide a system and a method for dissociating hydrocarbon fuels wherein the fuel may be liquid.

Still another advantage of the present invention is to provide a system and a method for dissociating hydrocarbon fuels wherein the fuel may be a gas.

Yet another advantage of the present invention is to provide a system and a method for dissociating hydrocarbon fuels wherein the hydrocarbon fuel may be gasoline.

Another advantage of the present invention is to provide a system and a method for dissociating hydrocarbon fuels wherein the hydrocarbon fuel may be kerosene.

An advantage of the present invention is to provide a system and a method for dissociating hydrocarbon fuels wherein the hydrocarbon fuel may be diesel.

Still another advantage of the present invention is to provide a system and a method for dissociating hydrocarbon fuels wherein the hydrocarbon fuel may be heating oil.

Yet another advantage of the present invention is to provide a system and a method for dissociating hydrocarbon fuels wherein the hydrocarbon fuel may be bunker fuel.

Another advantage of the present invention is to provide a system and a method for dissociating hydrocarbon fuels wherein the hydrocarbon fuel may be crude oil.

Still another advantage of the present invention is to provide a system and a method for dissociating hydrocarbon fuels wherein the hydrocarbon fuel may be natural gas.

Yet another advantage of the present invention is to provide a system and a method for dissociating hydrocarbon fuels wherein the hydrocarbon fuel may be high hydrogen coals.

Still yet another advantage of the present invention is to provide a system and a method for dissociating hydrocarbon fuels wherein the hydrocarbon fuel may be any petroleum or bio-derived hydrocarbon fuel.

An advantage of the present invention is to provide a system and a method for dissociating hydrocarbon fuels wherein the hydrocarbon fuel may be a solid fuel including high hydrogen coal, oil shale, tar sand, or any hydrocarbon that is in solid form.

Yet another advantage of the present invention is to provide a system and a method for dissociating hydrocarbon fuels wherein the hydrocarbon fuel may be natural gas, propane, LPG, acetylene, or other gaseous hydrocarbon.

Another advantage of the present invention is to provide a system and a method for dissociating hydrocarbon fuels wherein the hydrocarbon fuel may be input into a chamber where the hydrogen and solid particulate dissociate from each other.

An advantage of the present invention is to provide a system and a method for dissociating hydrocarbon fuels wherein the carbon to hydrogen chemical bonds are broken so that hydrogen may form molecular free hydrogen.

An advantage of the present invention is to provide a system and a method for dissociating hydrocarbon fuels wherein the system includes a fuel reformer for separating the fuel into solid and gaseous particles.

Still another advantage of the present invention is to provide a system and a method for dissociating hydrocarbon fuels into a gaseous hydrogen and solid particles wherein the system may reflux some of the dissociated hydrogen back into the system to further facilitate dissociation.

Another advantage of the present invention is to provide a system and a method for dissociation of hydrocarbon fuels without oxidizing the mixture.

An advantage of the present invention is to provide a system and a method for dividing the hydrocarbon fuel into a gaseous hydrogen state and a solid particulate wherein the solid particulate is primarily carbon.

Another advantage of the present invention is to provide a system and a method for providing an output of gaseous hydrogen and solid particulate that may be used in fuel cell technology.

Still another advantage of the present invention is to provide a system and a method for separating the hydrogen gas from the solid particulate.

Another advantage of the present invention is to provide a system and a method for separating the hydrogen gas from the solid particulate using acoustic flocculation.

Another advantage of the present invention is to provide a system and a method to divide hydrocarbon fuels by using fuel atomization.

Yet another advantage of the present invention is to provide a system and a method for separating hydrocarbon fuels by using fuel atomization where the hydrocarbon is fed through a dividing device such as a nozzle to divide the hydrocarbon into small droplets.

Still another advantage of the present invention is to provide a system and a method for dissociating the small droplets of hydrocarbon fuels by using a dissociating means wherein the dissociating means dissociates the gaseous hydrogen from the solid particulate by a means of radio frequency discharge.

An advantage of the present invention is to provide a system and a method for separating the hydrogen gas from the solid particulate using acoustic flocculation in which the solid particles in an aerosol collide with each other and stick together, to become large enough that they will fall out of the aerosol due to the force of gravity.

These and other objects of the invention will become more clear when one reads the following specification. The scope of protection sought by the inventors may be gleaned from a fair reading of the claims that conclude this specification.

Additional features and advantages of the present invention are described in, and will be apparent from the detailed description of the presently preferred embodiments and from the drawings.

### DESCRIPTION OF THE DRAWINGS

FIG. 1 is an illustration of the system for dividing, dissociating and separating the hydrocarbon fuel without the need for oxidizing the hydrocarbon fuel.

FIG. 2 is another illustration of the system for dividing and separating the hydrocarbon fuel with a carbon fuel cell attached.

### DESCRIPTION OF THE PREFERRED EMBODIMENT

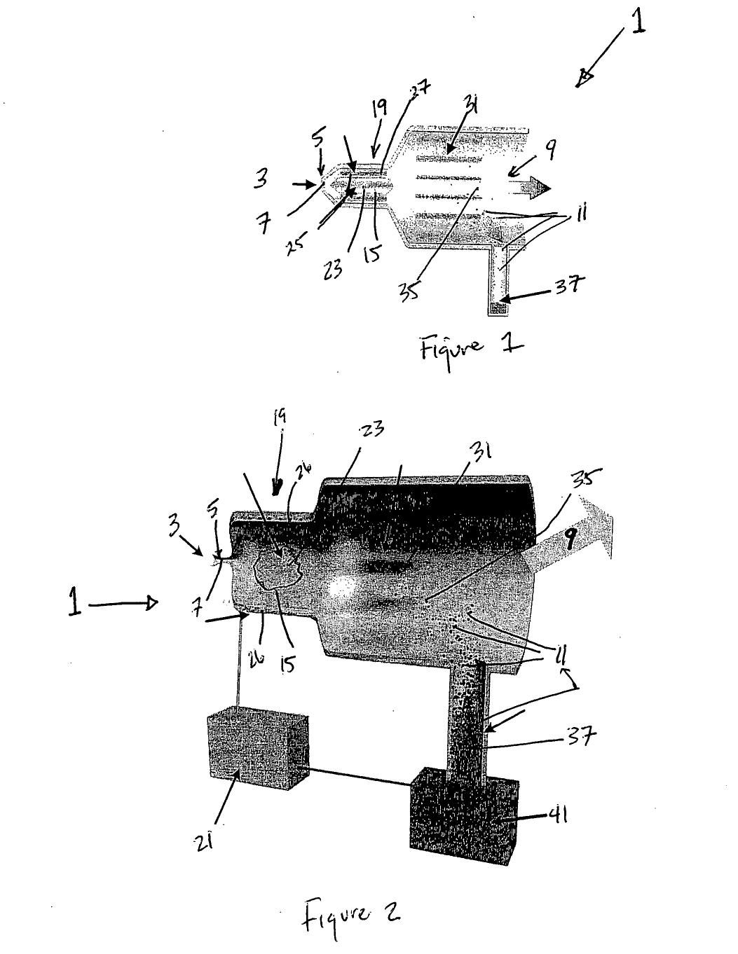

Turning now to the drawings wherein elements are identified by numbers and like elements are identified by like numbers throughout the 2 figures, the invention is depicted in FIG. 1 that shows a system 1 for reforming a hydrocarbon fuel 3 without the need for oxidizing the hydrocarbon fuel 3.

Hydrocarbon fuel 3 may come from a variety of physical forms. For example, the fuel may be solid, liquid and/or gas. However, in an embodiment of the present invention, the hydrocarbon fuel 3 may be in non-gaseous form In another embodiment of the invention, the hydrocarbon fuel 3 may be in gaseous form. The non-gaseous hydrocarbon fuel 3 may be gasoline, kerosene, diesel, heating oil, bunker fuel, or even crude oil, among others. Natural gas may also be used as the initial stock fuel for the reformer, as well as high hydrogen coals.

As illustrated in FIG. 1, in a preferred embodiment of the present invention, the hydrocarbon fuel 3 may be fed through a dividing means 5 to divide the hydrocarbon fuel 3 into smaller droplets. In an embodiment, the present invention may use a nozzle 7 to divide the hydrocarbon fuels 3 into smaller droplets. However, in another embodiment of the present invention, the dividing means 5 may be a injector (not shown), grinder (not shown), atomizer (not shown) or any other dividing means to divide the hydrogen fuels into smaller droplets that are small enough such that the hydrocarbon fuel 3 may be more easily dissociated to produce gaseous hydrogen 9 and solid particles 11.

As illustrated in FIG. 1 and FIG. 2, the hydrocarbon fuel 3 that has been divided into smaller droplets may be dissociated into gaseous hydrogen 9 and solid particulate 11. The dividing of the hydrocarbon fuel 3 may be by a dividing means 5. The process of dividing the hydrocarbon fuel 3 into small droplets is referred to as atomization of hydrocarbon fuels 3.

The hydrocarbon fuel 3 may be broken down into small droplets by using atomizers (not shown) or nozzles 7 or injectors (not shown) for liquid fuels. The fuel may also be broken down when dispensed through use of a dust nozzle (not shown), injectors (not shown), grinders (not shown) or other means for dividing solid hydrocarbon fuels 3 and introducing them to the dissociation means 19.

As illustrated in FIGS. 1 and 2, after the dividing the hydrocarbon fuel 3 into smaller droplets, the divided hydrocarbon fuel 3 may then be input into a RF plasma chamber 15 where the gaseous hydrogen 9 and solid particulate 11 are dissociated from each other. The dissociation breaks apart the carbon-hydrogen chemical bonds to form molecular hydrogen (H₂) and solid carbon where the carbon may form solid particles. The dissociation of the hydrocarbon may be performed by a dissociation means 19. The dissociation means 19 may emit a radio frequency discharge from a radio frequency amplifier 21 so as to form a plasma 23 in the divided hydrocarbon fuel 3. The process of dissociation of the hydrocarbon fuel 3 may take place in a radio frequency plasma chamber 29. The plasma 23 may be formed by a capacitive discharge device 25 as illustrated in FIG. 1, or an inductive coil device 26 as illustrated in FIG. 2. The capacitive discharge device 25 may be a plurality of metal rods 27 that separate the gas and allow for ionization of the hydrocarbon fuel 3 resulting in the plasma 23 formation. The inductive coil 26 may be a coil wire that allows for the formation of the radio frequency plasma 23 in the radio frequency plasma chamber 15. The dissociation of the hydrocarbon fuel 3 may be performed by the radio frequency (RF) discharge plasma 23 created by capacitive 25 or inductive coil discharge 26. This RF plasma 23 discharge can be tuned to frequencies or a frequency which most efficiently dissociates the carbon-hydrogen bond. The characteristics of this radio frequency discharge can be varied to optimize the efficiency of dissociation of the carbon-hydrogen bond. Frequency variations can alter the electron energy distribution of the discharge which can then be made to tailor the electron energy to that required for carbon-hydrogen bond dissociation. If the radio frequency discharge is also tuned to have an adequate impedance match with the plasma, the upper energy end of the distribution of electron energies in the plasma may efficiently and selectively break the carbon-hydrogen bond in the hydrocarbon fuel. This process has been demonstrated to be efficient in the dissociation of methyl iodide for chemical oxygen iodine lasers.

FIG. 1 and FIG. 2 illustrate the reformer system 1 that may have a separating means 31 to separate the flowing hydrogen gas 9 from the solid particulate 11 entrained in the hydrogen gas 9. The separation of the hydrogen gas 9 from the solid particulate 11 may be accomplished by using the separating means 31 on the gaseous hydrogen 9 and solid particulate 11 mixture. The separating means 31 may be an intense acoustic field applied to the flowing hydrogen gas 9 which contains the suspended solid particulate 11. This process is commonly referred to as acoustic flocculation. Alternatively, separation may be carried about by using filter membranes (not shown), electromagnetic separation techniques (not shown), the use of a bias voltage on a substrate in the bottom of the separation means (not shown), by vortex separator action (not shown), or any other small particle separation technique. With acoustic flocculation the solid particles 11 in an aerosol collide with each other, and stick together to become large enough that they will fall out of the aerosol due to the force of gravity. This process will remove most of the finely divided solid particles 11 from an aerosol in a short duration of time. The separating means 31 may cause solid particulate agglomeration 35 which separates the solid particles 11 from the gaseous hydrogen 9. The solid particles 9 may be channeled into a particulate chamber 37 to be used in a carbon fuel cell 41 as illustrated in FIG. 2. The particulate chamber 37 may channel the separated solid particles 11 to the carbon fuel cell 41 where the solid particles 11 may be used by the carbon fuel cell 41 to produce energy. Similarly, the gaseous hydrogen 9 may be channeled away from the separating means 31, to be used in a hydrogen fuel cell (not shown) to be used to produce energy.

It should be understood that various changes and modifications to the presently preferred embodiments described herein will be apparent to those skilled in the art. Such changes and modifications may be made without departing from the spirit and scope of the present invention and without diminishing its attendant advantages.

1. A system for reforming non-gaseous hydrocarbon fuels comprising:
a dispensing means for dividing the hydrocarbon fuel into small droplets;
a dissociating means for dissociating the hydrocarbon fuel into hydrogen gas and solid particles;
a separating means for separating said solid particles from said hydrogen gas.

2. The system for reforming hydrocarbon fuels as recited in claim 1 further comprising:
said dispensing means for separating the hydrocarbon fuel wherein said dispensing means is a nozzle.

3. The system for reforming hydrocarbon fuels as recited in claim 1 further comprising:
said dispensing means for separating the hydrocarbon fuel wherein said dispensing means is a injector, grinder, atomizer or other means of dividing into very small particles or droplets.

4. The system of claim 1 further comprising:
the dissociating means wherein said dissociating mean converts the hydrocarbon fuel into gaseous hydrogen and solid particles by using a radio frequency discharge plasma that efficiently dissociates the Carbon-Hydrogen bond.

5. The system of claim 1 further comprising:
the dissociating means wherein said dissociating means converts the hydrocarbon fuel into gaseous hydrogen and solid carbon by using radio frequency plasma discharge tuned to any frequency or frequencies that most efficiently dissociates the carbon-hydrogen bond.

6. The system of claim 1 further comprising:
the separating means for separating said solid particles from said hydrogen gas wherein said separating means is acoustic flocculation.

7. The system of claim 1 further comprising:
the separating means for separating said solid particles from said hydrogen gas wherein said separating means is filter membranes, electromagnetic separating techniques, the use of a bias voltage on a substrate in the bottom of the separation means, or use of other small particles separation techniques.

8. The system of claim 1 further comprising:
the separating means for separating said solid particles from said hydrogen gas wherein said separating means is acoustic flocculation further wherein said acoustic flocculation agglomerates the solid carbon particulate to increase the mass of each particle to the point that the force of gravity will separate the agglomerated particles from the flowing hydrogen stream.

9. A system for reforming gaseous hydrocarbon fuels comprising:
a dissociating means for dissociating the hydrocarbon fuel into hydrogen gas and solid particles;
a separating means for separating said solid particles from said hydrogen gas.

10. The system of claim 9 further comprising:
the dissociating means wherein said dissociating means converts the hydrocarbon fuel into gaseous hydrogen and solid particles by using a radio frequency discharge plasma that efficiently dissociates the carbon-hydrogen bond.

11. The system of claim 9 further comprising:
the dissociating means wherein said dissociating means converts the hydrocarbon fuel into gaseous hydrogen and solid particles by using radio frequency plasma discharge tuned to any frequency or frequencies that most efficiently dissociates the carbon-hydrogen bond.

12. The system of claim 9 further comprising:
the separating means for separating the dissociated hydrocarbon into solid particles and gaseous particles wherein said separating means is acoustic flocculation and further wherein said acoustic flocculation agglomerates the solid particles to increase the mass of each particles to the point that the force of gravity will separate the agglomerated particles from the flowing hydrogen stream.

13. The system of claim 9 further comprising:
the separating means for separating the dissociated hydrocarbon into solid particles and gaseous particles wherein said separating means is filter membranes, electromagnetic separating techniques, the use of a bias voltage on a substrate in the bottom of the separating means, or use of other small particles separation techniques.

14. A method for producing gaseous hydrogen and solid particles from non-gaseous hydrocarbon fuels, the method comprising the steps of:
dividing the fuel into very small particles;
dissociating the hydrocarbon fuel particles into gaseous hydrogen and solid particles;
separating said solid particles from the gaseous hydrogen.

15. The method described in claim 14 further comprising the step of:
providing a means of dividing hydrocarbon fuel into particles wherein hydrogen-carbon bonds that exist in the hydrocarbon fuel may be broken wherein said means of dividing hydrocarbon fuel is a nozzle, injector, grinder, atomizer, or other means to divide the hydrocarbon fuels into small particles or droplets.

16. The method described in claim 14 further comprising the step of:
providing a means of dissociating the solid particles from the hydrogen and producing gaseous hydrogen and solid particulate wherein said dissociating means is a radio frequency plasma discharge.

17. The method described in claim 14 further comprising the step of:
providing a means of dissociating the solid particles carbon from the hydrogen and producing gaseous hydrogen and solid particulate wherein said dissociating means is plasma discharge created by a capacitive or inductive coil discharge device.

18. The method described in claim 14 further comprising the step of:
providing a means of separating the gaseous hydrogen from the solid particles such that the gaseous hydrogen and the solid particles can then be used in their natural state wherein said separating means is acoustic flocculation to agglomerate the solid particles to increase the mass of each particle to the point that the force of gravity separates the agglomerated particles from a hydrogen stream.

19. The method described in claim 14 further comprising the step of:
providing a means of separating the gaseous hydrogen from the solid particles such that the gaseous hydrogen and the solid particles can then be used in their natural state wherein said separating means is electromagnetic separation techniques, bias voltage on a substrate in the bottom of the separation means that will attract the solid particulate and cause the solid particulate to settle and be removed, or any small particle separating technique to remove the solid particle from the divided hydrocarbon fuel.

20. The method described in claim 14 further comprising the step of:
reforming hydrocarbon fuels for a fuel cell which does not oxidize the hydrocarbon fuel.

21. The method described in claim 14 further comprising the step of:
producing a solid particle fuel in addition to the gaseous hydrogen.

22. The method described in claim 14 further comprising the step of:
removing the solid particulate from the gaseous hydrogen.

23. The method described in claim 14 further comprising the step of:
utilizing the solid particles in a carbon fuel cell and utilizing the gaseous hydrogen in a hydrogen fuel cell.

24. A method for producing gaseous hydrogen and solid particles from gaseous hydrocarbon fuels, the method comprising the steps of:
dissociating the hydrocarbon fuel into gaseous hydrogen and solid particles;
separating the dissociated solid particles from the gaseous hydrogen.

25. The method of claim 24 further comprising the step of:
providing a means of dissociating the solid particles from the hydrogen and producing gaseous hydrogen and solid particulate wherein said dissociating means is a radio frequency plasma discharge.

26. The method of claim 24 further comprising the step of:
providing a means of dissociating the solid particles carbon from the hydrogen and producing gaseous hydrogen and solid particulate wherein said dissociating means is plasma discharge created by a capacitive or inductive coil discharge device.

27. The method described in claim 24 further comprising the step of:
providing a means of separating the gaseous hydrogen from the solid particles such that the gaseous hydrogen and the solid particles can then be used in their natural state wherein said separating means is acoustic flocculation to agglomerate the solid particles to increase the mass of each particle to the point that the force of gravity separates the agglomerated particles from a hydrogen stream.

28. The method described in claim 24 further comprising the step of:
providing a means of separating the gaseous hydrogen from the solid particles such that the gaseous hydrogen and the solid particles can then be used in their natural state wherein said separating means is electromagnetic separation techniques, bias voltage on a substrate in the bottom of the separation means that will attract the solid particulate and cause the solid particulate to settle and be removed, or any small particle separating technique to remove the solid particle from the divided hydrocarbon fuel.

29. The method described in claim 24 further comprising the step of:
reforming hydrocarbon fuels for a fuel cell which does not oxidize the hydrocarbon fuel.

30. The method described in claim 24 further comprising the step of:
producing a solid particle fuel in addition to the gaseous hydrogen.

31. The method described in claim 24 further comprising the step of:
removing the solid particulate from the gaseous hydrogen.

32. The method described in claim 24 further comprising the step of:
utilizing the solid particles in a carbon fuel cell and utilizing the gaseous hydrogen in a hydrogen fuel cell.
